(19) United States
(12) Patent Application Publication
(10) Pub. No.: US 2002/0015004 A1
(43) Pub. Date: Feb. 7, 2002

(54) Information response system, information response method, and computer program for implementing the method

(75) Inventors: Tatsuya Chino, Shiojiri-shi (JP); Hiroshi Matsumoto, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 09/887,252

(22) Filed: Jun. 25, 2001

(30) Foreign Application Priority Data
Jun. 30, 2000 (JP) 2000-199362

(51) Int. Cl. G09G 5/00

(52) U.S. Cl. 345/2.1

(57) ABSTRACT

An information response system for communicating a response information to an informant answering a public information provided by the informant has a display selector (121) for selecting a display (4, 6) out of a plurality of displays (4, 6) onto which the public information is displayed, a response information receiver (131) for receiving the response information answering the displayed public information, and a response information communicator (15) for communicating the response information received by the response information receiver (131) to the informant. Since the display selector (121) is provided, the informant can designate the display (4, 6) for displaying the public information, so that localized response information can be obtained.

### BACKGROUND OF THE INVENTION

1. Field of the Invention

The present invention relates to an information response system, an information response method and a computer program for implementing the method for communicating a response information answering a public information distributed by an informant, which can, for instance, be suitably used for curbside questionnaire performed in a specific area.

2. Description of Related Art

In selling products and offering service, a curbside questionnaire etc. is conducted in order to investigate client's response toward the product and the service.

Further, since the number of clients using Internet has increased in accordance with recent popularization of computers, product seller and service provider set up their own homepages to publish information on the products etc., whereby the response of the client toward the published products etc. is collected via e-mail etc.

However, since a lot of work force is necessary for distributing and collecting the questionnaire in order to conduct curbside questionnaire and since counting work thereof is troublesome, the response to the products etc. cannot be efficiently obtained.

Further, since the information is spread over and collected from the whole world in the Internet, the response of clients within a specific area cannot be collected, so that localized information cannot be obtained.

### SUMMARY OF THE INVENTION

An object of the present invention is to provide an information response system, an information response method and a computer program for implementing the method capable of efficiently obtaining localized information.

An information response system according to an aspect of the present invention is for communicating a response information answering a public information provided by an informant, the information response system includes: a display selector for selecting a display out of a plurality of displays onto which the public information is displayed; a response information receiver for receiving the response information answering the displayed public information; and a response information communicator for communicating the response information received by the response information receiver to the informant.

The present invention can be constructed as a network system connecting a service terminal for the informant to provide the public information, a response terminal for a user to output a response information and a server computer through a network such as the Internet, where the display selector, the response information receiver, and the response information communicator are preferably provided in the server computer. The public information is provided by the informant using communication function of the service terminal through web browser for browsing the information in the server computer or a mailer.

The service terminal and the response terminal may be mobile terminal such as cellular phone, PDA (Personal Digital Assistants) having communication function as well as a home personal computer.

The display refers to an image display and multimedia information display installed in public space etc., which may be, for instance, large-size PDP (Plasma Display Panel) installed at station square, a projection system for forming projection image on building exterior and windows, and liquid display installed inside of transport facilities such as train and bus.

According to the aspect of the present invention, since provision of display selector enables for the informant to distribute and display the public information only to a predetermined area, the response information is not gathered from homepage on the Internet made open to the whole world, so that the response information answering the public information can be obtained in a more localized manner.

Further, since the response information receiver is provided, the response information can be easily output using the mobile terminal connectable to the network. Further, since the response information communicator is provided, the response information answering the public information can be easily communicated to the service terminal computer connected to the network, so that troublesome work such as distribution, collection and counting of questionnaire as in curbside questionnaire can be avoided, thus efficiently collecting response information answering public information.

In the above, the information response system of the above aspect of the present invention may preferably further include a response information storage for storing the response information received by the response information receiver.

Since the response information storage is provided, the public information can be repeatedly displayed on the image display for a certain period of time for obtaining the response information answering the public information, so that the response of the clients can be more accurately grasped with more response information.

In the above, the information response system of the above aspect of the present invention may preferably further include a response information modifier for processing the response information stored in the response information storage.

The modification of the response information means to count and process the response information into contents easy for the informant to understand.

Since the response information modifier is provided, the informant can obtain the data after counting the questionnaire, counting work of the informant can be omitted, thus more efficiently conducting the collection of client information by the informant.

In the above information response system of the above aspect of the present invention, the display selector may preferably select the display based on the area-designating information added to the public information.

Since the display selector selects the image display based on the distribution area-designating information attached to the public information, the informant can selectively designate the area to which the public information is displayed, thus enabling to collect the response information in accordance with the needs of the informant.

In the above information response system of the above aspect of the present invention, when the response information is output from the mobile terminal, a terminal location information collector for collecting a location information of a mobile terminal being output from the mobile terminal may preferably be provided.

Since the terminal location information collector is provided, the location where the client transmits the response information can be recognized. Accordingly, by utilizing the information in information collection such as questionnaire for counting in view of the information, multiphase counting result can be obtained.

The present invention can be arranged not only as the above-described information response system, but may be arranged as an information response method having a display selecting step, a response information receiving step and a response information communicating step, and a computer program for implementing the method (circulated in a storage medium or a transmission medium such as network), where the same functions and effects can be obtained.

According to the information response method of the present invention, the respective steps may not necessarily be performed by a single computer constituting the network but all the steps may be implemented with combination of a plurality of computers. Further, according to the computer program according to the present invention, since the system of the present invention can be constructed using a commercial computer, the applicability of the present invention can be greatly extended.

### BRIEF DESCRIPTION OF THE DRAWINGS

FIG. 1 is a schematic drawing showing a network setup of information response system according to an embodiment of the present invention;

FIG. 2 is a block diagram showing a structure of a server constituting the information response system of the aforesaid embodiment;

FIG. 3 is a conceptual illustration showing a structure of a database of public information stored in a public information storage of the aforesaid embodiment;

FIG. 4 is a conceptual illustration showing a structure of a database of response information stored in a response information storage of the aforesaid embodiment;

FIG. 5 is a conceptual illustration showing a structure of a database of location information stored in a location information storage of the aforesaid embodiment;

FIG. 6 is a flowchart for illustrating a function of the information response system of the aforesaid embodiment;

FIG. 7 is an example of input screen for entering the public information of the aforesaid embodiment;

FIG. 8 is a flowchart for illustrating a function of the information response system of the aforesaid embodiment;

FIG. 9 is an example of display screen displayed in the information response system of the aforesaid embodiment;

FIG. 10 is a flowchart showing a function of the information response system of the aforesaid embodiment; and

FIG. 11 is a flowchart for illustrating a function of the information response system of the aforesaid embodiment.

### DETAILED DESCRIPTION OF PREFERRED EMBODIMENT(S)

An embodiment of the present invention will be described below with reference to attached drawing.

[Arrangement of Information Response System]

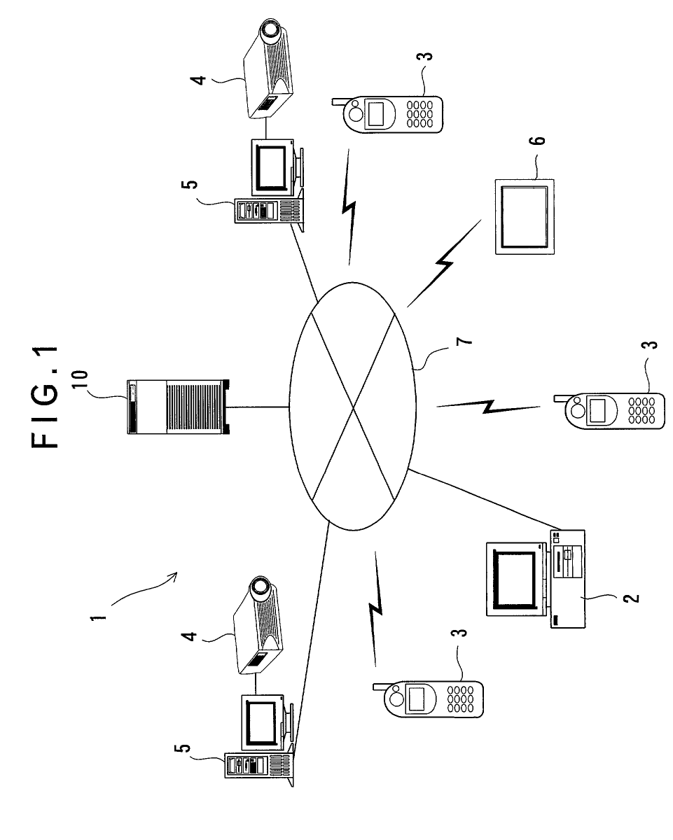

FIG. 1 shows an information response system 1 according to an embodiment of the present invention. The information response system 1 has a service terminal computer 2 as a service terminal, a mobile terminal 3 as a response terminal, an image display 4, a terminal computer 5 directly connected to the image display 4, an image display 6, and a server 10, which are connected via network 7 such as the Internet.

The service terminal computer 2 is a computer for the informant to enter public information such as questionnaire. The service terminal computer 2 includes a processor such as CPU (Central Processing Unit) and a storage, where web browser is installed on an OS (Operating System) for controlling function of the CPU. Though not shown, the service terminal computer 2 is connectable with the network 7 by a modem etc. through a public circuit. The informant uses a below-described public information collector 14 provided in the server 10 through the web browser.

The mobile terminal 3 is a machine for outputting a response information answering the public information provided by the informant, which may be cellular phone etc. such as PHS (Personal Handy-phone System). The mobile terminal 3 is arranged so that the server 10 receives the terminal location information of the mobile terminal 3, for instance as follows. The mobile terminal 3 may have GPS (Global Positioning System) function, so that the mobile terminal 3 periodically can output latitude information and longitude information of the present location. Alternatively, using receiving base station constituting the PHS, the signal output from the mobile terminal 3 may be received by a plurality of base stations, so that approximate location information of the mobile terminal 3 may be obtained based on the receiving condition of the plurality of base stations, which is output to the server 10.

The image display 4 and the terminal computer 5 are arranged as a projection system installed at a public space such as station and park. Distributed information output from the server 10 is input to the terminal computer 5 through the network 7 and the modem, which is displayed as a large-screen projection image by the image display 4.

In the same manner, the image display 6 is a multimedia information terminal installed at a public space such as station and park, which is composed of liquid crystal display etc. for a user to manipulate an input device (not shown) to search desired information.

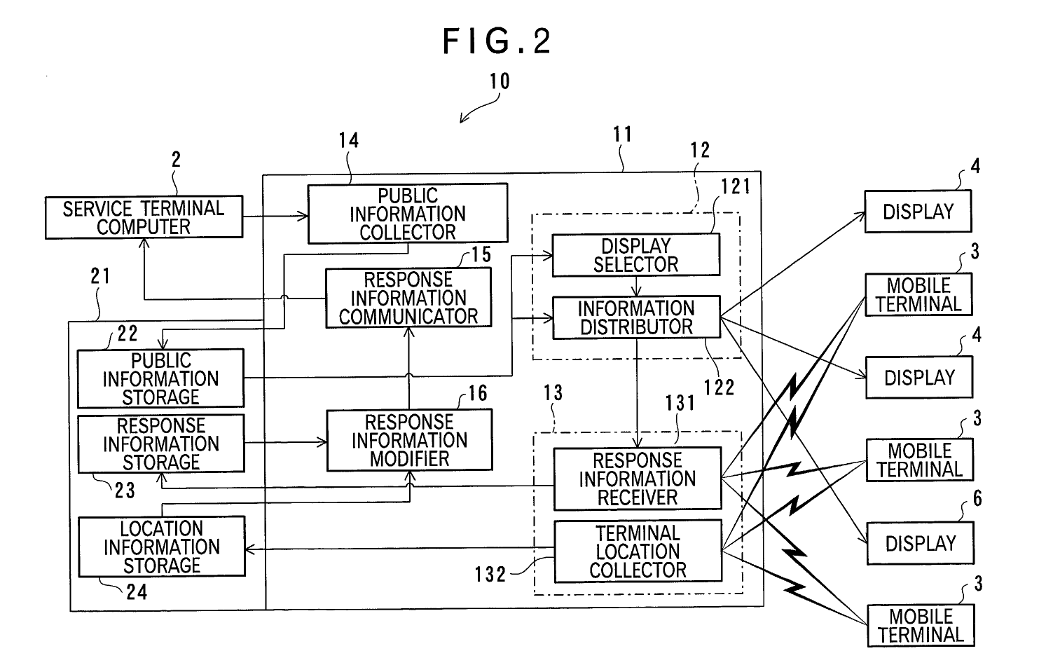

As shown in FIG. 2, the server 10 has a CPU 11 and a storage 21. A distribution information output 12, a response information collector 13, a public information collector 14, a response information communicator 15 and a response information modifier 16 are constructed as a computer program on the OS having a multi-task function for controlling the function of the CPU 11. A public information storage 22, a response information storage 23 and location information storage 24 are set in the storage 21.

The distribution information output 12 has a display device selector 121 and an information distributor 122. The display selector 121 selects the image displays 4 and 6 for displaying the public information based on a area-designating information added to the public information input by the informant. The information distributor 122 specifically delivers a public information to the selected image displays 4 and 6.

The response information collector 13 collects the response information which the client, who sees the public information, outputs by operating the mobile terminal 3. The response information collector 13 includes a response information receiver 131 and a terminal location information collector 132.

The response information receiver 131 receives the contents of specific response information output by the mobile terminal 3 of the client. When the client transmits a response information corresponding to questionnaire items attached to public information after the client operates the mobile terminal 3 to connect to the network 7 for accessing to the server 10, the response information is received by the response information receiver 131.

The terminal location information collector 132 collects location information of the mobile terminal 3 when the response information is output by the mobile terminal 3. When the client inputs telephone number to establish connection with the response information receiver in order to output the response information, the mobile terminal 3 simultaneously outputs the current location information thereof, which is collected by the terminal location information collector 132.

The public information collector 14 is for collecting the public information input by the informant with the service terminal computer 2. When the informant accesses the server 10, the input screen is displayed onto which the informant enters public information. The public information entered by the informant is, for instance, introduction of product and service provided by the informant, and questionnaire items as to the introduced products and services. The public information collector 14 collects distribution time and area of the public information designated by the informant together with collecting the public information.

The response information communicator 15 sends back the response information of the client collected by the response information receiver 131 and counted result thereof. The collected response information or the counted result is output to the service terminal computer 2 by the response information communicator 15 through the network 7.

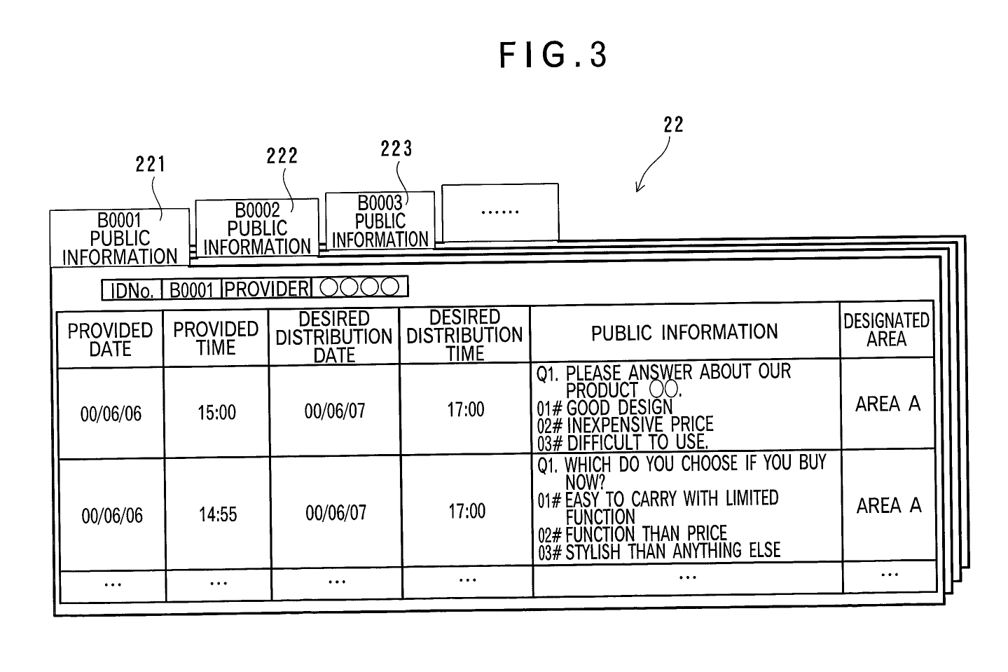

The public information storage 22 temporarily stores the public information from the informant collected by the public information collector 14, which is converted into a database having a plurality of tables 221, 222, 223 . . . as designed by the informant as shown in FIG. 3. The information stored in the respective tables 221, 222, 223 . . . includes ID number for identifying the public information, specific contents of the public information, desired distribution time and distribution area designating information etc.

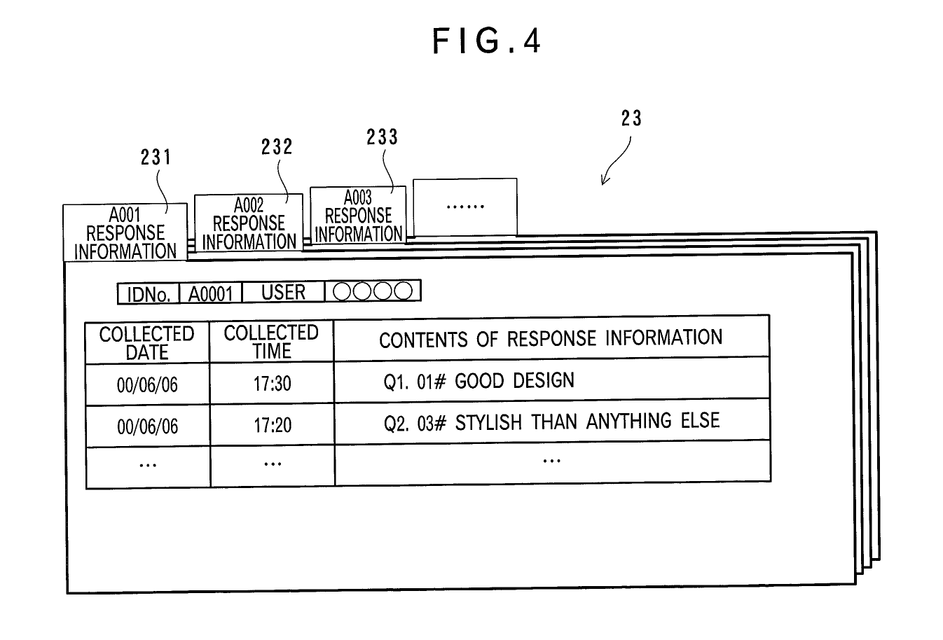

The response information storage 23 is for storing the response information received by the response information receiver 131, which is converted into a database having a plurality of tables 231, 232, 233 . . . in accordance with ID number of the mobile terminal outputting the response information as shown in FIG. 4. The information stored in the respective tables 231, 232, 233 . . . includes ID number for identifying the public information to be responded, specific contents of the response information, specific contents of response etc.

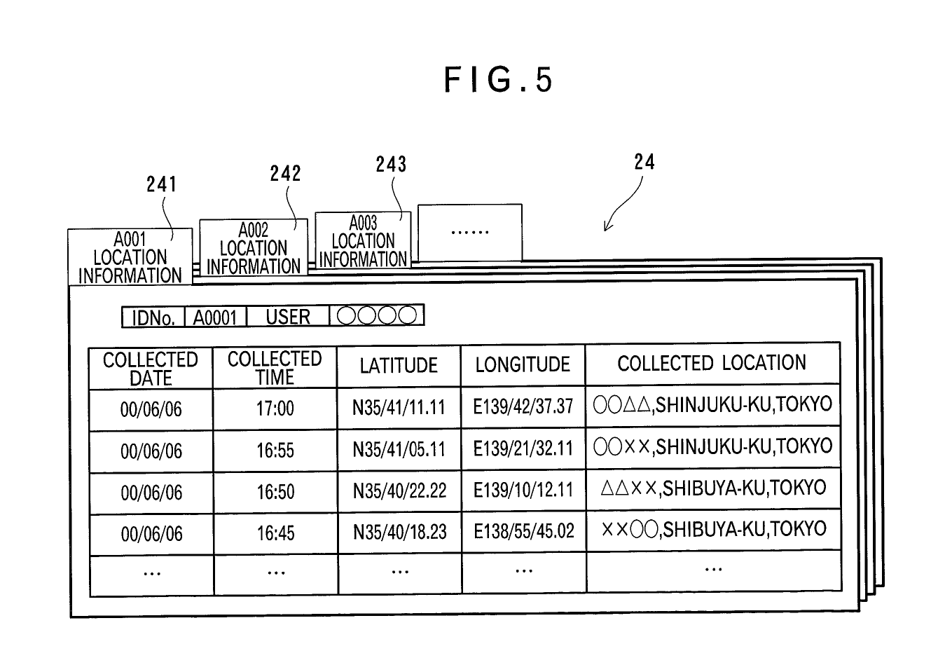

The location information storage 24 is for storing location information of the mobile terminal 3 collected by the terminal location information collector 132, which is converted into a database having a plurality of tables 241, 242, 243 . . . which is set according to the ID number of the mobile terminal 3 in outputting the response information, as shown in FIG. 5. The information stored in the respective tables 241, 242, 243 . . . includes collected time of the location information, latitude and longitude information representing the location information and current position information representing the location information etc. Incidentally, when the mobile terminal 3 has GPS function and outputs the location information using GPS function, the latitude and longitude information is initially input, whereby the location information can be obtained. On the other hand, when the mobile terminal 3 uses the base station of PHS, the location information calculated by the plurality of base stations is initially input, based on which approximate latitude and longitude information can be obtained.

[Function of Information Response System]

Next, a function of the information response system 1 will be described below. The function of the information response system 1 can be roughly classified into collection of public information, delivery of public information, collection of response information, and transfer of the response information, which are independently conducted using multi-task function of OS. Each of the respective functions will be separately described below.

(1) Collection of Public Information

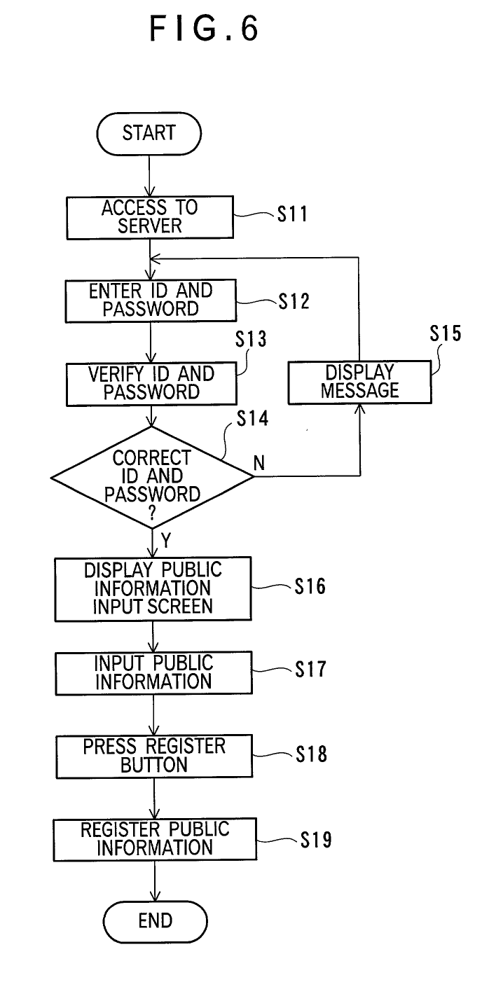

The public information is collected according to flowchart shown in FIG. 6.

Initially, the informant starts the web browser of service terminal computer 2 to access the server 10 (step S11). When the server 10 is accessed, a screen requesting input of ID and password is displayed. When the informant enters his ID and password, (step S12), the public information collector 14 confirms input of the ID and the password (step S13) and judges whether the ID is right or not (step S14). If the ID is wrong, the public information collector 14 displays a message to the effect on the service terminal computer 2 (step S15) and displays a screen requesting to re-enter the ID and password.

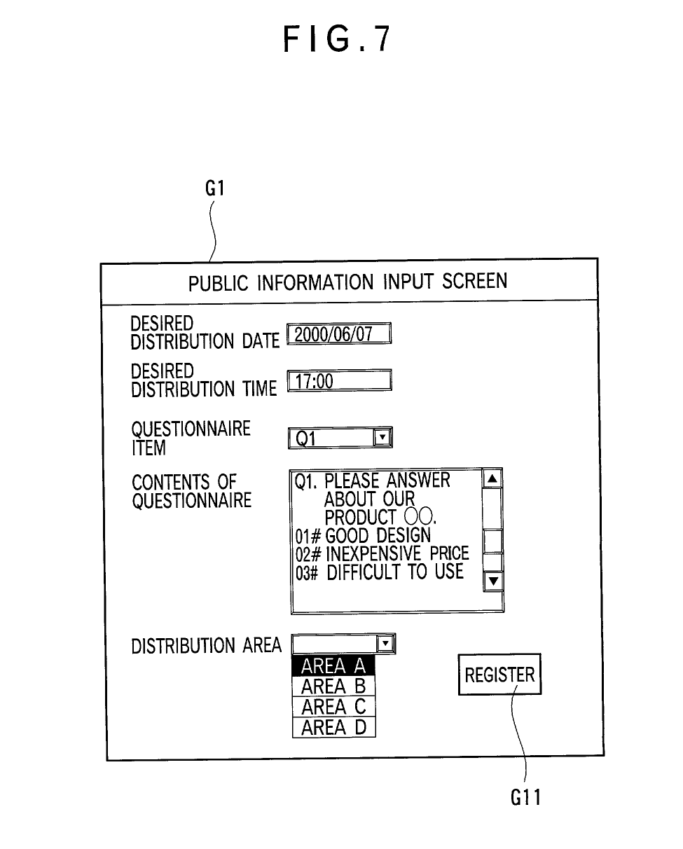

On the other hand, when the public information collector 14 judges that right ID and password are input, a public information input screen G1 is displayed as shown in FIG. 7 (step S16) and the informant inputs the public information according to the input screen G1 (step S17). Specifically, the informant inputs desired distribution time, contents of public information and area to be distributed as shown in FIG. 7.

When input operation is completed, the informant presses a register button G11 after confirming the registered contents are correct (step S18). When the register button G11 is pressed, the public information collector 14 stores the public information entered on the input screen GI into the public information storage 22 (step S19). Specifically, the public information collector 14 sets one table as, for instance, the table 221 shown in FIG. 3 based on the ID number of the informant, and stores the time when the register button G11 is pressed, an information upload time, desired distribution time, desired distribution area and specific contents of the public information stores in one record.

(2) Delivery of Public Information

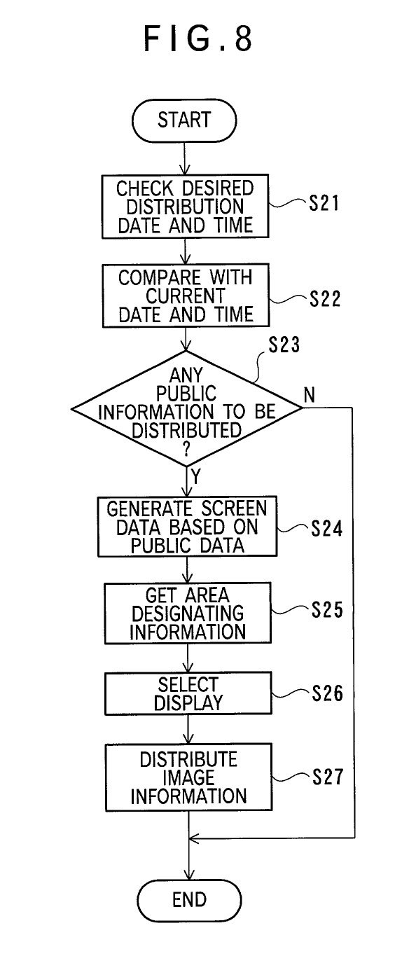

The public information is distributed according to a flowchart shown in FIG. 8.

Initially, though not shown in FIG. 2, the distribution information output 12 periodically checks the desired distribution date and time of the public information registered in the public information storage 22 (step S21). The distribution information output 12 compares the current date and time detected by internal clock etc. with the desired distribution date and time (step S22) to determine whether the public information corresponding to the desired distribution date and time exists or not (step S23).

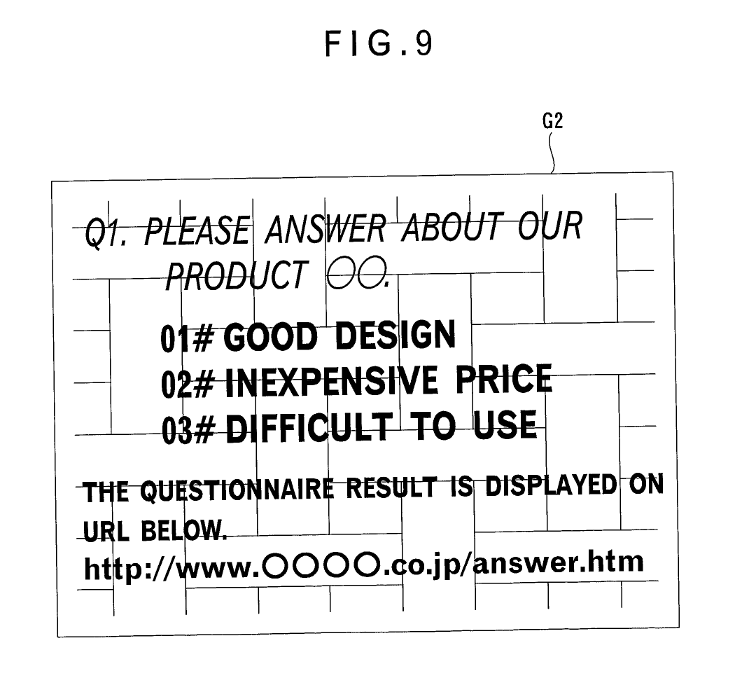

When there is public information to be distributed, the information distributor 122 obtains the public information stored in the public information storage 22, and produces an image information G2 after modifying and adding the size of the characters, layout and background, as shown in, for instance, FIG. 9 (step S24).

On the other hand, the display selector 121 obtains the distribution area-designating information of the public information stored in the public information storage 22 (step S25) and selects the image displays 4 and 6 based on the area-designating information (step S26), so that the result is output to the information distributor 122. During selection, a database storing relationship between the area section divided in a predetermined size and the image displays 4 and 6 located within the respective areas is used to select the corresponding image displays 4 and 6 based on the area-designating information of the public information storage 22.

After the image information is produced, the information distributor 122 delivers the image information to the image displays 4 and 6 selected by the display selector 121 (step S27). Incidentally, the image information is repeatedly distributed by the information distributor 122 at a predetermined interval so that the clients can acknowledge invitation to the questionnaire.

(3) Collection of Response Information

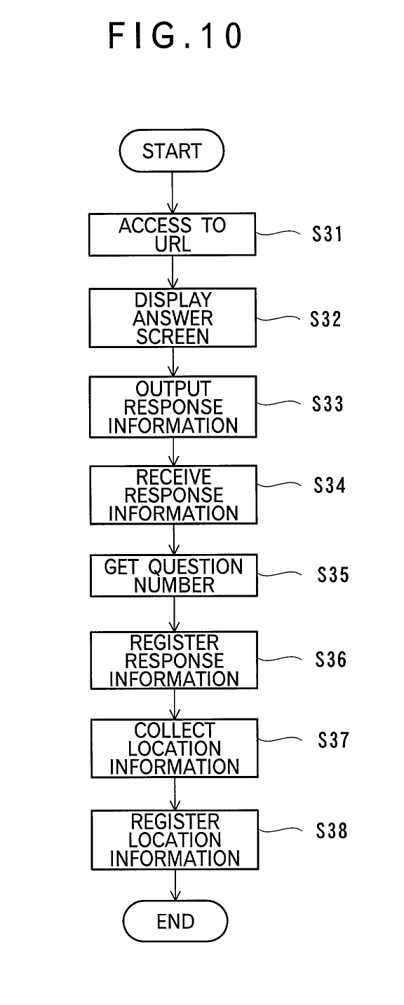

The response information is collected according to flowchart shown in FIG. 10.

When a client having seen the image information G2 of FIG. 9 displayed on the image displays 4 and 6 outputs an answer to the questions, the client accesses the URL displayed on the image information G2 by operating the mobile terminal 3 (step S31). After accessing, an answer screen is displayed on the image display of the mobile terminal 3 (step S32), then, the client enters the number of the answer to output the response information (step S33).

After the response information is received by the response information receiver 131 (step S34: response information receiving step), the response information receiver 131 obtains which question number is displayed on the image displays 4 and 6 (step S35) from the information distributor 122 and registers the response information corresponding to the question in the response information storage 23 (step S36: response information storing step).

When the response information is output, the terminal location information collector 132 collects the current location information of the mobile terminal 3 (step S37: terminal location information collecting step). The current location information may be collected by outputting the latitude and longitude information simultaneously obtained by GPS function in outputting the response information from the mobile terminal 3 having the GPS function, or may alternatively be collected by obtaining the current location information of the mobile terminal 3 using the system for obtaining location information such as PHS.

When the current location information is obtained, the terminal location information collector 132 registers the location information to the location information storage 24 (step S38).

(4) Transfer of Response Information

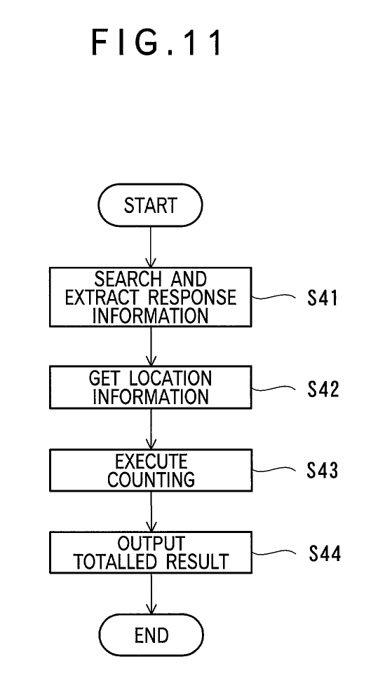

The response information is communicated according to flowchart shown in FIG. 11.

The response information from a plurality of clients stored in the response information storage 23 during the above-mentioned “collection of response information” is modified by the response information modifier 16. Specifically, the response information modifier 16 searches and extracts the response information for every questions from every respective tables 231, 232, 233 . . . of the response information storage 23 (step S41). Further, the response information modifier 16 obtains the location information of the mobile terminal 3 when the respective location information is obtained from the location information storage 24 (step S42).

The response information modifier 16 implements counting work based on these information (step S43: response information modifying step). The counting work is conducted by counting the response information for each area divided from the designated areas based on the location information of the mobile terminal 3 or by counting the response information classified by age, sex etc. based on a separately prepared user information database storing the user information of the mobile terminal 3.

After completing counting work, the response information modifier 16 outputs the counting result to the response information communicator 15. The response information communicator 15 outputs the counting result to the service terminal computer 2 through the network 7 (step S44).

[Effect of the Embodiment]

According to the above-described embodiment, following effect can be obtained.

Since provision of display selector 121 enables for the informant to distribute and display the public information only to a predetermined area, the response information is not gathered from the homepage made open to the whole world, so that the response information answering the public information can be obtained in a more localized manner.

Further, since the response information receiver 131 is provided, the response information can be easily output using the mobile terminal 3 connectable to the network 7. Further, since the response information communicator 15 is provided, the response information answering the public information can be easily communicated to the service terminal computer 2 connected to the network 7, so that troublesome work such as distribution, collection and counting work of questionnaire as in curbside questionnaire can be avoided, thus efficiently collecting response information answering public information.

Further, since the response information storage 23 is provided, the public information can be repeatedly displayed on the image displays 4 and 6 for a certain period of time for obtaining the response information answering the public information, so that the response of the clients can be more accurately grasped with more response information.

Since the response information modifier 16 is provided, the informant can obtain the data after counting the questionnaire, counting work of the informant can be omitted, thus more efficiently conducting the collection of client information by the informant.

Since the display selector 121 selects the image displays 4 and 6 based on the distribution area-designating information attached to the public information, the informant can selectively designate the area to which the public information is displayed, thus enabling to collect the response information in accordance with the needs of the informant.

Further, since the terminal location information collector 132 is provided, the location where the client transmits the response information can be recognized. Accordingly, by utilizing the response information modifier 16 collected by the terminal location information collector 132 in the response information modifier 16, multiphase counting can be conducted and a total result easy to be utilized for the informant can be output.

[Modifications]

Incidentally, the present invention is not restricted to the above-described embodiments, but includes following modifications as long as an object of the present invention can be achieved.

Though the mobile terminal 3 is a cellular phone in the embodiment, but equipments such as PDA and handy navigator having communication function may be used as the mobile terminal.

Though the public information provided by the informant includes a predetermined questionnaire items in the above-described embodiment, the present invention may be applied other than the questionnaire collection system. Specifically, the present invention can be used as a reservation system for providing reservation condition of restaurants and hotels as public information, so that the client seeing the information can apply for reservation of the restaurant and the hotel by a mobile terminal.

Though the image displays 4 and 6 are fixed to public space etc. in the aforesaid embodiment, the arrangement is not limited. Specifically, an image display such as a liquid crystal display installed in a bus or train may be set as a display of the public information. Incidentally, since the image display moves together with the bus etc. in this arrangement, it is preferable that a display location information collector for collecting the location information of the image display is separately provided.

Though the distribution information output 12 and the response information collector 13 are provided in a single server 10, the information response system of the present invention may be arranged as a system having a plurality of servers.

Though the information response system 1 is arranged as the network 7 using a network such as the Internet, the information response system 1 may be arranged as LAN (local area network).

Further, though the image display 4 composed of a projector and the image display 6 composed of a liquid crystal display are used as the display in the aforesaid embodiment, a display using LED and PDP etc. may be used as the image display.

The present invention is not only arranged as a system including the service terminal computer 2, the mobile terminal 3, the image displays 4 and 6 and server 10, but may be arranged as a method for functioning the devices and, further, as a computer program for implementing the method.

Though the response information is output by accessing the URL on the display screen G2 displayed on the image displays 4 and 6 with the mobile terminal 3, the arrangement is not limited. Specifically, the response information may be output as follows.

(1) The response information may be output in a manner similar to FAX service. Specifically, the number corresponding to options is set and displayed in displaying the questionnaire screen with the image display, and, simultaneously, the telephone number for connecting with the server is displayed. After establishing connection with the server, the mobile terminal is operated to enter the number corresponding to the selected options. After the number is entered, a decision button “#” is pressed to output the response information.

(2) The response information may be output using an e-mail transmission function of the cellular phone. Specifically, when the questionnaire screen is displayed on the image display, the mail address is displayed for each options. The respondent of the questionnaire outputs the response information to the mail address corresponding to the selected options. For instance, following setting is possible in the questionnaire screen shown in FIG. 9.

01# Good design→XXX@mail.com

02# Inexpensive price→YYY@mail.com

03# Difficult to use→ZZZ@mail.com

Such arrangement for outputting the response information enables for a cellular phone having no web-access function to utilize the present system.

Specific arrangements and steps in implementing the present invention may be alternatively arranged as long as an object of the present invention can be achieved.

What is claimed is:

1. An information response system for communicating a response information answering a public information provided by an informant, comprising:
a display selector for selecting a display out of a plurality of displays onto which the public information is displayed;
a response information receiver for receiving the response information answering the displayed public information; and
a response information communicator for communicating the response information received by the response information receiver to the informant.

2. The information response system according to claim 1, further comprising a response information storage for storing the response information received by the response information receiver.

3. The information response system according to claim 2, further comprising a response information modifier for processing the response information stored in the response information storage.

4. The information response system according to claim 1, wherein the display selector selects the display based on the area-designating information added to the public information.

5. The information response system according to claim 1, further comprising a terminal location information collector for collecting a location information of a mobile terminal, the response information being output from the mobile terminal.

6. An information response method for communicating a response information to an informant answering a public information provided by the informant, comprising:
display-selecting step for selecting a display out of a plurality of displays for displaying the public information;
a response information receiving step for receiving response information answering the displayed public information; and
a response information communicating step for communicating the response information received in the response information receiving step to the informant.

7. The information response method according to claim 6, further comprising the step of storing the response information received in the response information receiving step.

8. The information response method according to claim 7, further comprising the step of modifying the response information stored in the response information storing step.

9. The information response method according to claim 6, wherein the display is selected in the display selecting step based on a area-designating information added to the public information.

10. The information response method according to claim 6, further comprising a collecting terminal location information step for collecting a location information of a mobile terminal, the response information being output from the mobile terminal.

11. A computer program for implementing the information response method according to claim 6 with a computer system.

12. The computer program according to claim 11, further implements storing the response information received in the response information receiving step.

13. The computer program according to claim 12, further implements modifying the response information stored in the response information storing step.

14. The computer program according to claim 11, wherein the display is selected in the display selecting step based on a area-designating information added to the public information.

15. The computer program according to claim 11, further implements collecting a location information of a mobile terminal, the response information being output from the mobile terminal.
